(19) United States
(12) Patent Application Publication
(10) Pub. No.: US 2010/0214319 A1
(43) Pub. Date: Aug. 26, 2010

(54) DISPLAY APPARATUS

(75) Inventor: Katsuya Nakano, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/709,244

(22) Filed: Feb. 19, 2010

(30) Foreign Application Priority Data
Feb. 23, 2009 (JP) 2009-039619
Jan. 21, 2010 (JP) 2010-010942

(51) Int. Cl. G09G 5/32

(52) U.S. Cl. 345/652

(57) ABSTRACT

An apparatus includes a detection unit configured to detect portrait/landscape orientation of the apparatus, a retrieval unit configured to retrieve, out of a plurality of image data, image data oriented according to the detected orientation, a display unit, and a control unit configured to display on the display unit an image relating to the retrieved image data.

### BACKGROUND OF THE INVENTION

1. Field of the Invention

The present invention relates to a display apparatus and, more particularly, to display control of an image.

2. Description of the Related Art

Some information terminals, such as mobile phones or personal digital assistances (PDAs) are configured to display an image read out of a memory card (see Japanese Patent Application Laid-Open No. 2002-23914). In recent years, a display apparatus called a digital photo frame including a liquid crystal panel having dimensions of approximately 5 to 10 inches and a memory card slot for reading out an image stored in a memory card and displaying the image has also been familiar.

In this type of apparatus, the portrait/landscape orientation of a display unit such as the liquid crystal panel can be easily changed. When the orientation of the display unit is changed, the orientation of an image to be displayed is also changed. Therefore, this type of apparatus generally has the function of changing the orientation of an image to be displayed.

If the orientation of the display unit is changed when an image is being displayed by the PDA or the like, as described above, a user may change the orientation of the image to be displayed.

On the other hand, some apparatuses of this type can use an image stored in the memory card as wallpaper. If the display unit is horizontally long, and the user may want to set a horizontally long image as wallpaper, the user is to retrieve an image in an orientation suitable for the wallpaper.

In addition thereto, if the user desires to display the image oriented according to the orientation of the display unit, the user is to retrieve and display the image suitable for the orientation of the display unit by himself/herself.

### SUMMARY OF THE INVENTION

According to an aspect of the present invention, an apparatus includes a detection unit configured to detect portrait/landscape orientation of the apparatus, a retrieval unit configured to retrieve, out of a plurality of image data, image data oriented according to the detected orientation, a display unit, and a control unit configured to display on the display unit an image relating to the retrieved image data.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIGS. 1A and 1B illustrate the appearance of a display apparatus according to an exemplary embodiment of the present invention.

FIG. 2 illustrates the configuration of the display apparatus.

FIG. 3 is a flowchart illustrating the operation of the display apparatus.

FIG. 4 is a flowchart illustrating processing for generating image data.

FIG. 5 is a flowchart illustrating an operation in a normal display mode.

FIG. 6 is a flowchart illustrating an operation in a switching display mode.

FIG. 7 is a flowchart illustrating an operation in a single display mode.

FIG. 8 is a flowchart illustrating an operation in a list display mode.

FIG. 9 is a flowchart illustrating an operation in a slide show mode.

FIGS. 10A to 10E illustrate various manners of a display screen.

FIGS. 11A to 11D illustrate various manners of a display screen.

FIG. 12 illustrates the appearance of a display system in the exemplary embodiment of the present invention.

FIG. 13 illustrates the configuration of a display control apparatus.

FIG. 14 is a flowchart illustrating the operation of a display control apparatus.

FIG. 15 is a flowchart illustrating an operation in connection confirmation processing.

FIG. 16 is a flowchart illustrating an operation in device information acquisition processing.

FIG. 17 is a flowchart illustrating an operation in a single display mode.

### DESCRIPTION OF THE EMBODIMENTS

Various exemplary embodiments, features, and aspects of the invention will be included in detail below with reference to the drawings.

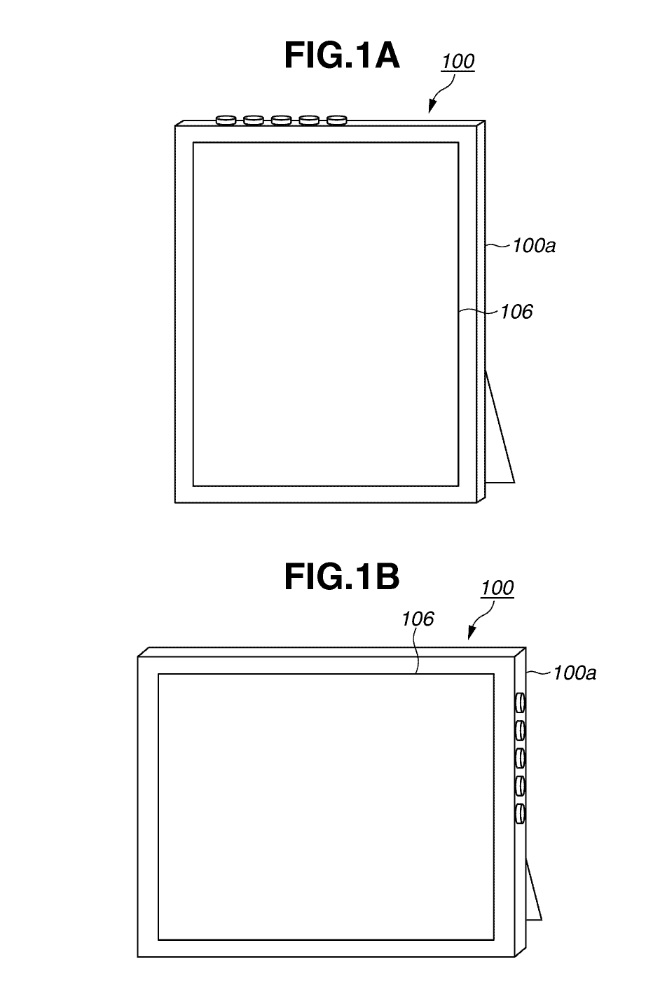

FIGS. 1A and 1B are diagrams illustrating the appearance of a display apparatus 100 according to an exemplary embodiment of the present invention. The display apparatus 100 can be installed with a casing 100a portrait-oriented and landscape-oriented, respectively, to a user facing the display apparatus 100, as illustrated in FIGS. 1A and 1B. More specifically, when the display apparatus 100 is installed in a state illustrated in FIG. 1A, the vertical length of a display unit 106 including a liquid crystal panel or the like is greater than the horizontal length thereof. This state is referred to as a portrait-oriented state. When the display apparatus 100 is installed in a state illustrated in FIG. 1B, the horizontal length of the display unit 106 is greater than the vertical length thereof. This state is referred to as a landscape-oriented state.

The display apparatus 100 includes a mechanism such as a slot for a user to freely mount and/or discharge a storage medium M such as a memory card. Image data such as still image data and moving image data stored in the storage medium M are read out, and images relating to the image data read out are displayed on the display unit 106. The display apparatus 100 includes a gravity sensor 107. The gravity sensor 107 detects the portrait/landscape orientation of the display apparatus 100. A display screen is controlled, as described below, according to the detected orientation.

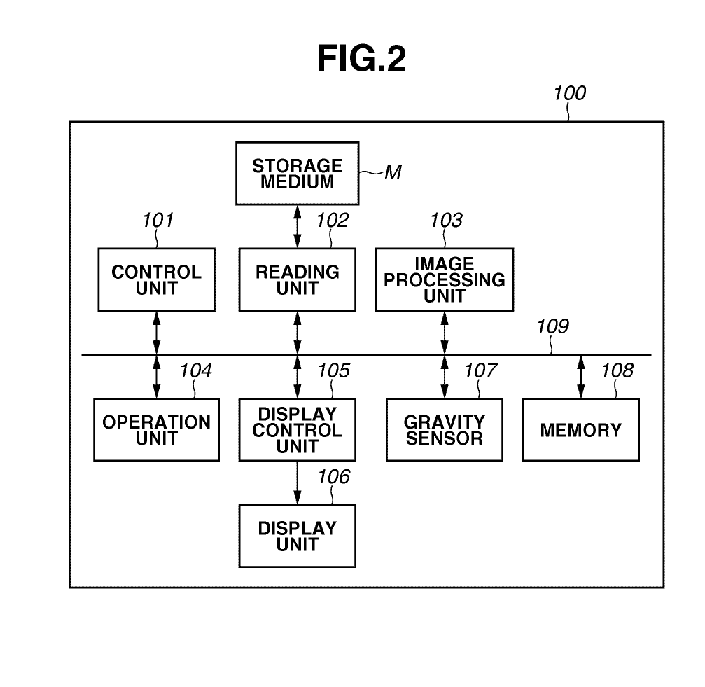

FIG. 2 is a functional block diagram illustrating the internal configuration of the display apparatus 100.

In FIG. 2, a control unit 101 controls the operation of the display apparatus 100. A reading unit 102 reads out the still image data and the moving image data from the storage medium M such as the memory card. Although in the present exemplary embodiment, processing performed when the still image data is read out of the storage medium M and displayed will be described, the moving image data can be similarly displaced. An image processing unit 103 includes a decoder for decoding the image data read out of the storage medium M and increasing the amount of information. The image processing unit 103 performs various types of image processing such as processing for changing the size of the decoded image data.

An operation unit 104 includes various types of operation switches such as a power switch, a mode switch for switching a mode, and a switch for switching an image to be displayed. In the present exemplary embodiment, the display apparatus 100 includes a remote controller for operating the display apparatus 100. The operation unit 104 includes the remote controller and a receiving unit for receiving a command from the remote controller. A display control unit 105 generates image data to be displayed and displays the generated image data on a display unit 106.

The display control unit 105 generates display image data representing various types of information such as a menu screen under an instruction from the control unit 101 in addition to the image data read out of the storage medium M, and displays the generated image data on the display unit 106. The display unit 106 includes a liquid crystal panel having dimensions of approximately several inches. An image is displayed on the display unit 105 according to the display image data from the display control unit 105. The gravity sensor 107 detects the portrait/landscape orientation of the display apparatus 100, and notifies the control unit 101 of the orientation by a known technique. More specifically, the gravity sensor 107 determines whether the display apparatus 100 is portrait-oriented or landscape-oriented, and notifies the control unit 101 of the orientation of the display apparatus 100.

A memory 108 includes a semiconductor memory such as a flash memory and a hard disk, and stores the image data read out of the storage medium M. The control unit 101 stores various types of information in the memory 108. Various types of data are sent and received via a data bus 109 among blocks.

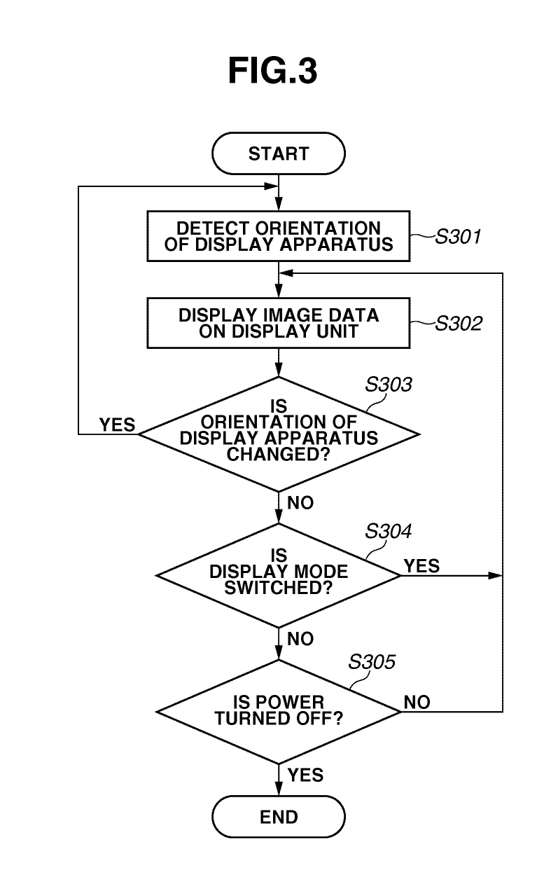

The operation of the display apparatus 100 will be then described. FIG. 3 is a flowchart illustrating the operation of the display apparatus 100. Processing illustrated in FIG. 3 is performed by the control unit 101 controlling each of the units.

In step S301, the control unit 101 causes the gravity sensor 107 to detect the orientation of the display apparatus 100 when the power is turned on. In step S302, the control unit 101 causes the image processing unit 103 to generate display image data and display an image on the display unit 106, described below, according to the orientation of the display apparatus 100. In step S303, the control unit 101 determines whether the user changes the orientation of the display apparatus 100 when the image is being displayed and the gravity sensor 107 detects that the orientation of the display apparatus 100 has been changed.

If the orientation of the display apparatus 100 is changed (YES in step S303), the processing returns to step S301. If the orientation of the display apparatus 100 is not changed (NO in step S303), then in step S304, the control unit 101 determines whether the user operates the operation unit 104, to issue an instruction to switch a display mode.

The display apparatus 100 has a normal display mode and a switching display mode. The normal display mode means a mode for automatically changing the orientation and the size of an image according to the orientation of the display apparatus 100 and displaying the image.

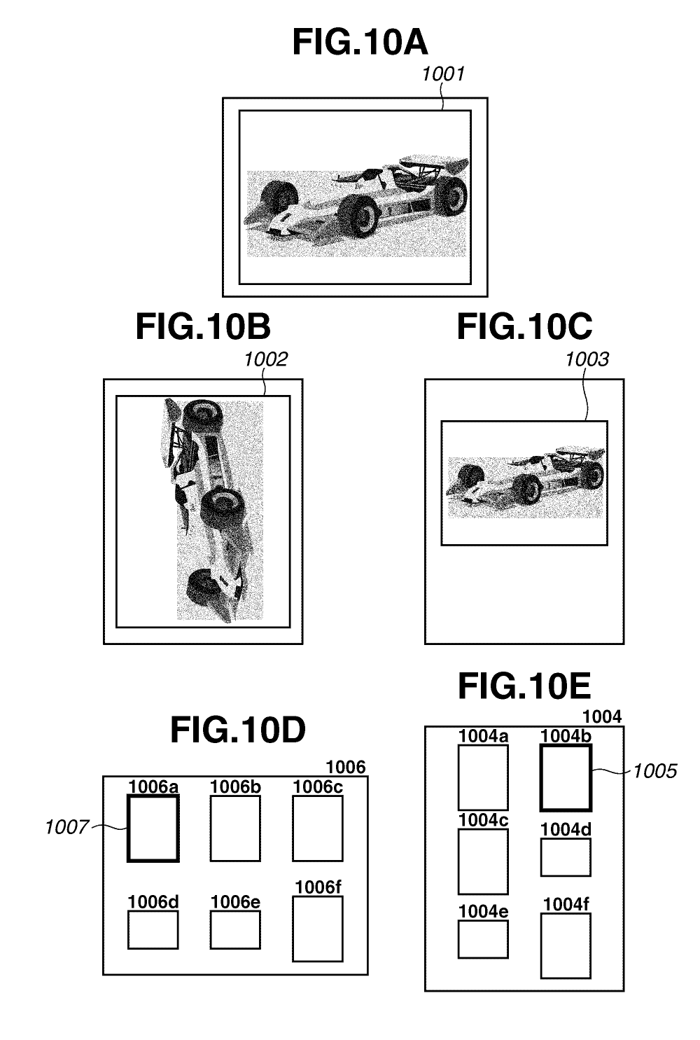

If the display apparatus 100 is landscape-oriented, and a landscape-oriented image is displayed on the display unit 106, for example, a landscape-oriented image 1001 is displayed, as illustrated in FIG. 10A. When the display apparatus 100 is portrait-oriented in this state, a portrait-oriented image 1002 is displayed, as illustrated in FIG. 10B. The portrait-oriented image 1002 is not easy to view.

In such a case, a landscape-oriented image 1003 whose orientation is changed and whose size is further reduced according to the horizontal length of the display unit 106 is automatically displayed, as illustrated in FIG. 10C.

On the other hand, the switching display mode means a mode for automatically retrieving an image oriented according to the orientation of the display apparatus 100 and displaying the retrieved image. In the switching display mode, when the orientation of the display apparatus 100 is changed while the image is being displayed, as described below, the image that is currently being displayed is automatically switched to an image oriented according to the orientation of the display apparatus 100 after the switching.

If the instruction to switch the display mode between the normal display mode and the switching display mode is issued (YES in step S304), the processing returns to step S302. In step S302, image data to be displayed is generated according to the display mode set after the switching. If the instruction to switch the display mode is not issued (NO in step S304), then in step S305, the control unit 101 determines whether an instruction to turn the power off is issued.

If the instruction to turn the power off is not issued (NO in step S305), the processing returns to step S302. If the instruction to turn the power off is issued (YES in step S305), the power to the display apparatus 100 is turned off, to terminate the processing.

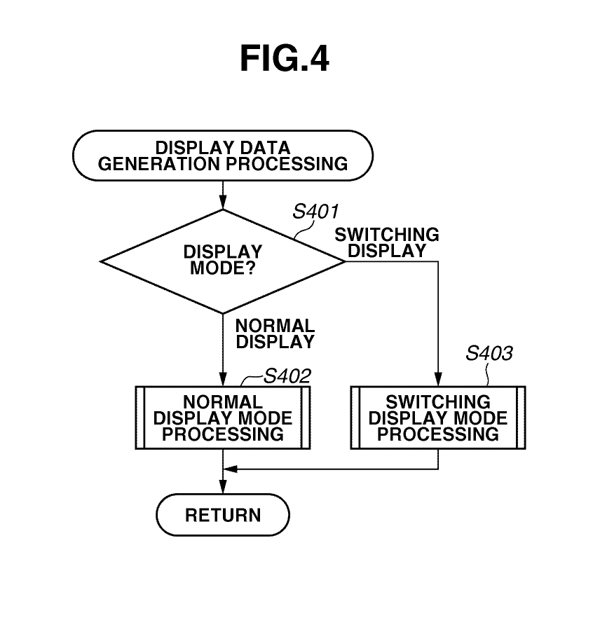

Display data generation processing will be then described. FIG. 4 is a flowchart illustrating the display data generation processing. Processing illustrated in FIG. 4 is performed by the control unit 101 controlling each of the units, and is repeatedly performed while the power to the display apparatus 100 is turned on.

In step S401, the control unit 101 first determines whether the display mode is set to the normal display mode or the switching display mode. If the normal display mode is set, then in step S402, normal display mode processing is performed. If the switching display mode is set, then in step S403, switching display mode processing is performed.

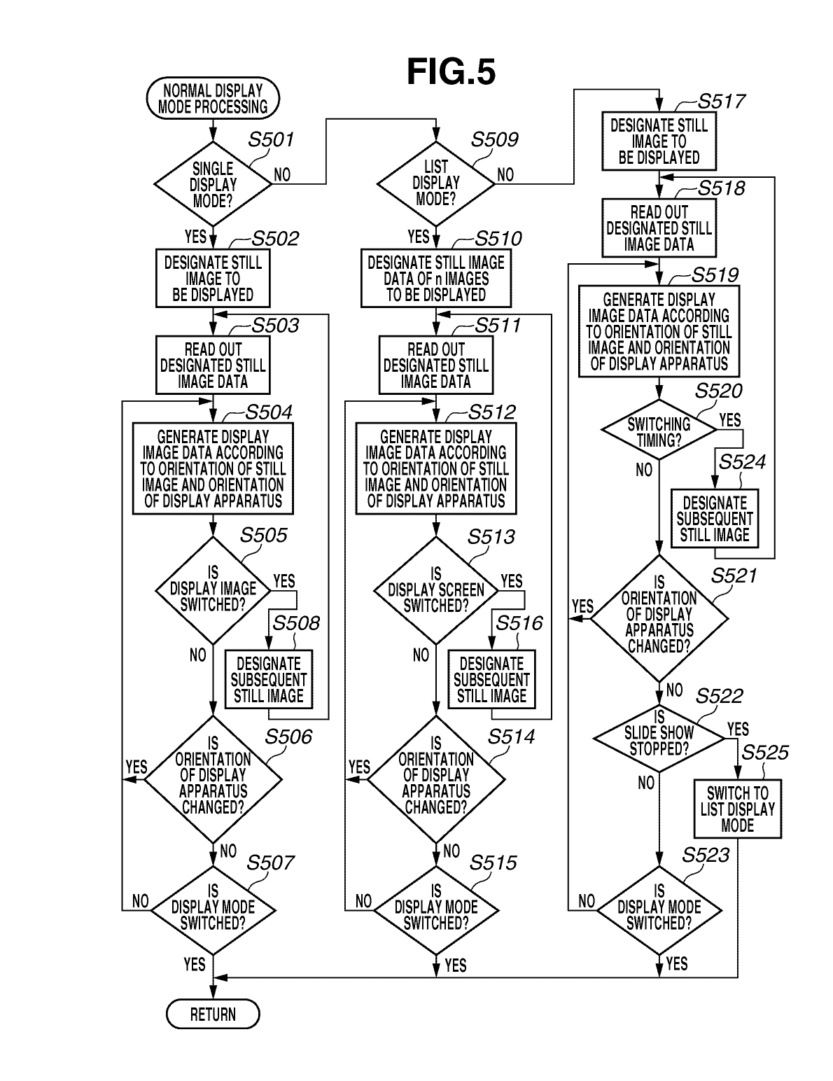

FIG. 5 is a flowchart illustrating the normal display mode processing in step S402. The processing illustrated in FIG. 5 is also performed by the control unit 101 controlling each of the units. In the present exemplary embodiment, each of the normal display mode and the switching display mode has three modes, i.e., a single display mode for displaying one image on one display screen, a list display mode for displaying a list of a predetermined number of reduced images, and a slide show mode. The user can set and switch any one of the three modes by operating the operation unit 104. In the exemplary embodiment, described below, a case where still image data is read out of the storage medium M and displayed will be described.

In step S501, the control unit 101 determines whether the single display mode out of the three display modes is set. If the single display mode is set (YES in step S501), then in step S502, the control unit 101 designates one of the still image data stored in the storage medium M as a sill image to be displayed. A plurality of still image data is stored in a file format in the storage medium M according to a predetermined file system. The reading unit 102 reads out management information relating to each of the still image data from the storage medium M, and designates the still image data to be read out based on the management information.

Although the still image data stored on the earliest date is designated according to information relating to a storage date included in the management information, the still image data to be read out may be designated according to other conditions. If the still image data from the storage medium M has been displayed before, a still image last displayed may be stored in the memory 108, designated, and read out. If one of reduced images displayed in the list display mode is selected, and an instruction for switching to the single display mode is issued, as described below, the still image data corresponding to the reduced image selected on a list display screen is designated as a still image to be displayed.

If the still image data to be read out is designated, then in step S503, the control unit 101 causes the reading unit 102 to read out the designated still image data from the storage medium M. The control unit 101 causes the image processing unit 103 to decode the still image data read out, and stores the decoded still image data in the memory 108 once. In step S504, the control unit 101 determines the orientation of the still image data, and causes the image processing unit 103 to generate display image data based on the orientation of the still image data and the orientation of the display apparatus 100.

Processing for determining the orientation of the still image data will be described. Attribute information relating to a portrait/landscape orientation is added to a file storing each of the still image data according to a file system. If the still image data is in a JPEG (Joint Photographic Experts Group) format, for example, an Orientation tag stored in Exif (Exchangeable Image File Format) information is used as the attribute information. The Orientation tag is information indicating at which the still image data starts and in which orientation the still image data is stored. The portrait/landscape orientation of the image data can be determined with reference to the information.

In addition thereto, the portrait/landscape orientation of each of the still image data may be determined based on information relating to the vertical and horizontal dimensions (the number of pixels) of the still image data. The user may designate the portrait/landscape orientation of each of images and store information relating to the designated orientation in relation to each of the still image data to determine the orientation of the image. The control unit 101 determines the orientation of each of the image data stored in the storage medium M by these methods.

The display image data generated in this way is sent to the display control unit 105, and an image is displayed on the display unit 106. In step S505, the control unit 101 determines whether the use operates the operation unit 104 while the image is being displayed, to issue an instruction for switching to the subsequent image.

If the instruction for switching is issued (YES in step S505), then in step S508, the control unit 101 designates the still image subsequent to the still image that is currently being displayed. Then, the processing returns to step S503. If the instruction for switching is not issued (NO in step S505), then in step S506, the control unit 101 determines whether the orientation of the display apparatus 100 is changed.

If the orientation of the display apparatus 100 is changed (YES in step S506), the processing returns to step S504 because the size and the orientation of the image that is being displayed is to be changed, as described above. In step S504, the control unit 101 generates display image data again according to the orientation of the image and the orientation of the display apparatus 100. If the orientation of the display apparatus 100 is not changed (NO in step S506), then in step S507, the control unit 101 determines whether the user operates the operation unit 104, to issue an instruction to switch the display mode to any one of the other display mode, i.e., the switching display mode, the list display mode, and the slide show mode. If the instruction to switch the display mode is issued (YES in step S507), the processing exits the flow illustrated in FIG. 5.

If the single display mode is not set (NO in step S501), then in step S509, the control unit 101 determines whether the list display mode is set. If the list display mode is set (YES in step S509), then in step S510, the control unit 101 designates, out of the still image data stored in the storage medium M, the still image data of n (n is an integer of two or more) images to be displayed as a list. In the present exemplary embodiment, reduced images of still image data of six images are displayed in one display screen in the list display mode, for example. Although the still image data stored on the earliest date is first designated, as in the single display mode, the present invention is not limited to this.

In step S511, the control unit 101 causes the reading unit 102 to read out the designated still image data of six images from the storage medium M, and causes the image processing unit 103 to decode the still image data. In step S512, the control unit 101 determines the orientation of each of the still image data, and causes the image processing unit 103 to generate list display image data based on the orientation of the still image data and the orientation of the display apparatus 100. At this time, a cursor for selecting one of the reduced images, together with the reduced images, is displayed.

FIG. 10E illustrates how a list display screen 1004 is displayed in the normal display mode when the display apparatus 100 is portrait-oriented. As illustrated in FIG. 10E, six reduced images, i.e., portrait-oriented reduced images 1004a, 1004b, 1004c, and 1004f and landscape-oriented reduced images 1004d and 1004e are displayed on the list display screen 1004. The horizontal width of the landscape-oriented reduced images 1004d and 1004e is reduced according to the horizontal width of the portrait-oriented reduced images.

A cursor 1005 is displayed for the user selecting one of the reduced images. When the user operates the operation unit 104 to move the cursor 1005, to select one of the reduced images, and issues an instruction for reproduction in the state, the display mode is switched to the single display mode. The selected image is displayed in the single display mode, as illustrated in FIG. 10A or 10C.

FIG. 10D illustrates how a list display screen 1006 is displayed in the normal display mode when the display apparatus 100 is landscape-oriented. As illustrated in FIG. 10D, six reduced images, i.e., portrait-oriented reduced images 1006a, 1006b, 1006c, and 1006f and landscape-oriented reduced images 1006d and 1006e are displayed on the list display screen 1006. The horizontal width of the landscape-oriented reduced images 1006d and 1006e is reduced according to the horizontal width of the portrait-oriented reduced images.

In step S513, the control unit 101 determines whether the user issues an instruction to switch a display screen after the list display screen is displayed in this way. If the instruction to switch the display screen is issued (YES in step S513), then in step S516, the control unit 101 designates the still image to be displayed on the subsequent list display screen. Then, the processing returns to step S511. If the instruction to switch the display screen is not issued (NO in step S513), then in step S514, the control unit 101 determines whether the orientation of the display apparatus 100 is changed.

If the orientation of the display apparatus 100 is changed (YES in step S514), the processing returns to step S512. In step S512, the control unit 101 generates list display image data again. If the orientation of the display apparatus 100 is not changed (NO in step S514), then in step S515, the control unit 101 determines whether the user operates the operation unit 104, to issue an instruction to switch the display mode to any one of the other display mode, i.e., the switching display mode, the list display mode, and the slide show mode. If the instruction to switch the display mode is issued (YES in step S515), the processing exits the flow illustrated in FIG. 5.

If the list display mode is not set (NO in step S509), then in step S517, the control unit 101 determines that the slide show mode is set, to designate one of the still image data stored in the storage medium M as a still image to be first displayed. The still image data designated at this time is the same as in the single display mode. If the still image data to be read out is designated, then in step S518, the control unit 101 causes the reading unit 102 to read out the designated still image data from the storage medium M. The control unit 101 causes the image processing unit 103 to decode the still image data read out, and stores the decoded still image data in the memory 108 once. In step S519, the control unit 101 determines the orientation of the still image data, and causes the image processing unit 103 to generate display image data based on the orientation of the still image data and the orientation of the display apparatus 100.

In the slide show mode, an image to be displayed is automatically switched for each elapse of a predetermined period of time. After the first image is displayed, therefore, a self-contained counter is operated, to count the period of time elapsed since the image was displayed. In step S520, the control unit 101 determines whether timing of switching a display image is generated based on the value of the counter.

If the timing of switching a display image is generated (YES in step S520), then in step S524, the control unit 101 designates the still image subsequent to the still image that is currently being displayed. Then, the processing returns to step S518. If the timing of switching a display image is not generated (NO in step S520), then in step S521, the control unit 101 determines whether the orientation of the display apparatus 100 is changed.

If the orientation of the display apparatus 100 is changed (YES in step S521), the processing returns to step S519 because the size and the orientation of the image that is being displayed is to be changed. In step S519, the control unit 101 generates display image data again according to the orientation of the image and the orientation of the display apparatus 100. If the orientation of the display apparatus 100 is not changed (NO in step S521), then in step S522, the control unit 101 determines whether the user operates the operation unit 104, to issue an instruction to stop a slide show.

If the instruction to stop the slide show is issued (YES in step S522), then in step S525, the control unit 101 switches the display mode to the list display mode. Then, the processing exits the flow illustrated in FIG. 5. If the instruction to stop the slide show is not issued (NO in step S522), then in step S523, the control unit 101 determines whether an instruction to switch the display mode to any one of the other display mode, i.e., the switching display mode, the list display mode, and the slide show mode is issued. If the instruction to switch the display mode is issued (YES in step S523), the processing exits the flow illustrated in FIG. 5.

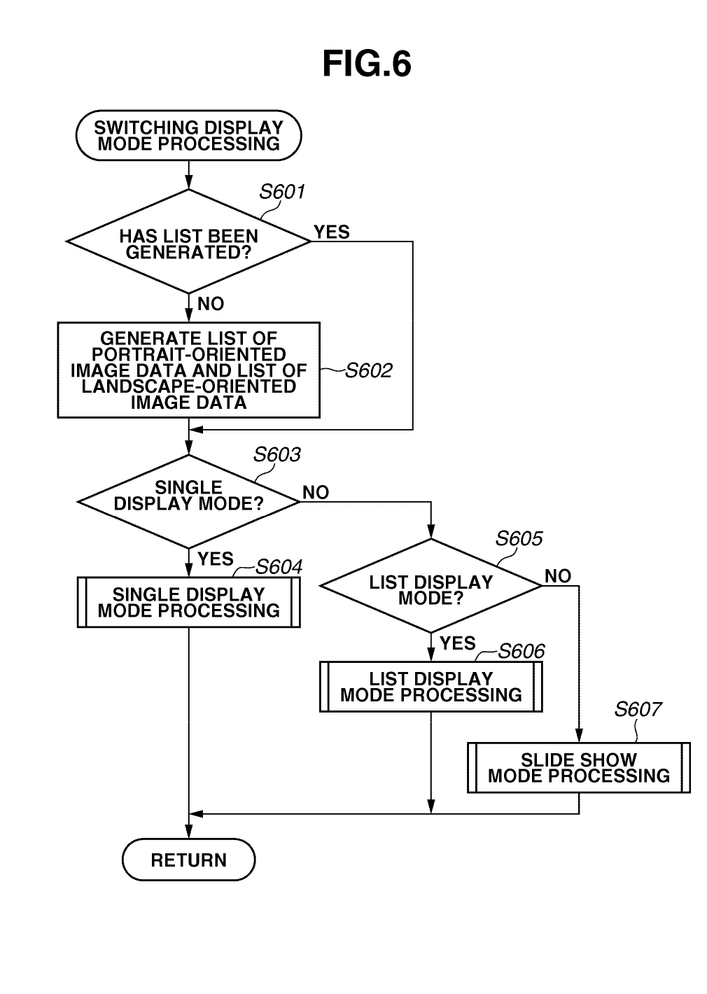

The switching display mode processing will be then described with reference to flowcharts illustrated in FIGS. 6 to 9. FIG. 6 is a flowchart illustrating the switching display mode processing in step S403. The processing in anyone of FIGS. 6 to 9 is performed by the control unit 101 controlling each of the units.

In step S601, the control unit 101 first determines whether lists respectively including portrait-oriented still image data and landscape-oriented still image data out of the still image data stored in the storage medium M have already be generated. If the lists are not generated (NO in step S601), the control unit 101 determines whether each of the still image data stored in the storage medium M is portrait-oriented or landscape-oriented based on attribute information relating to the still image data. As a result of the determination, the control unit 101 classifies the still image data into the portrait-oriented still image data and the landscape-oriented still image data. In step S602, the control unit 101 generates a list of portrait-oriented still image data and a list of landscape-oriented still image data, and stores the lists in the memory 108.

Each of the lists includes identification information capable of specifying the corresponding still image data, e.g., the file name of the still image data. Each of the lists includes information relating to the corresponding still image data in the order in which the still image data are stored. If each of the lists is stored in the memory 108 in step S602, the processing proceeds to step S603.

In step S603, the control unit 101 determines whether the single display mode is set. If the single display mode is set (YES in step S603), then in step S604, single display mode processing is performed. If the single display mode is not set (NO in step S603), then in step S605, the control unit 101 determines whether the list display mode is set. If the list display mode is set (YES in step S605), then in step S606, list display mode processing is performed. If the slide show mode is set (NO in step S605), then in step S607, slide show mode processing is performed.

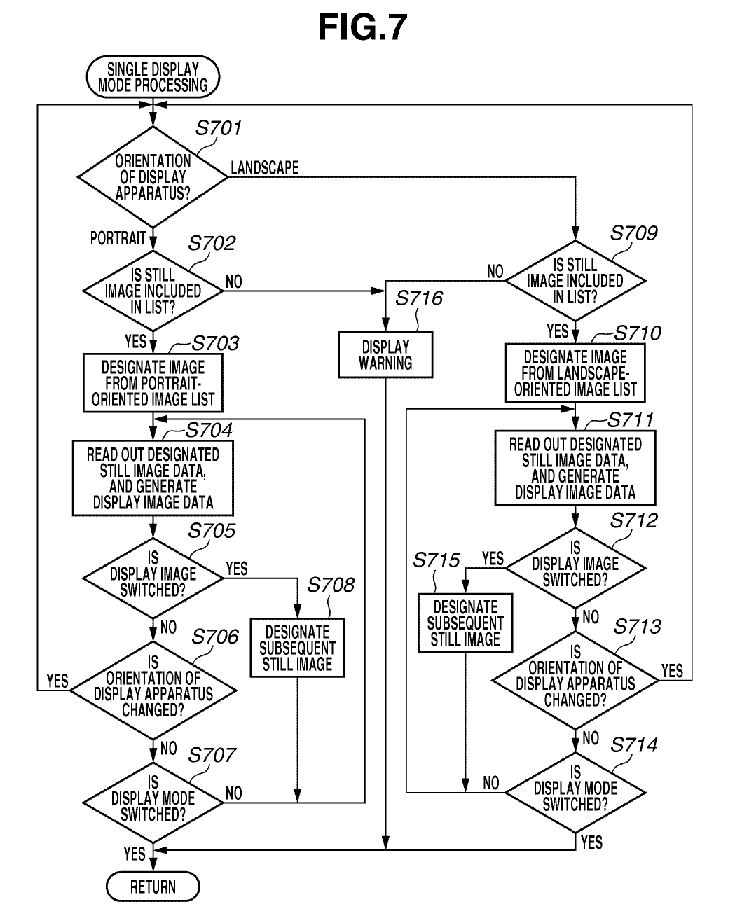

FIG. 7 is a flowchart illustrating the single display mode processing in step S604.

In step S701, the control unit 101 first detects the orientation of the display apparatus 100. If the display apparatus 100 is portrait-oriented, then in step S702, the control unit 101 determines whether still images are included in the portrait-oriented image list stored in the memory 108. If no still image is included in the list (NO in step S702), then in step S716, the control unit 101 displays on the display unit 106 a warning screen indicating that a portrait-oriented still image is not stored and cannot be displayed. Then, the processing exits the flow illustrated in FIG. 7.

If the still images are included in the portrait-oriented image list (YES in step S702), then in step S703, the control unit 101 designates the still image to be displayed from the portrait-oriented image list. At this time, if one of reduced images displayed in the list display mode is selected, and an instruction for switching to the single display mode is issued, the control unit 101 designates the still image data corresponding to the reduced image selected in the list display screen as the still image to be displayed.

In step S704, the control unit 101 causes the reading unit 102 to read out the designated still image data from the storage medium M, and causes the image processing unit 103 to generate display image data.

The image processing unit 103 generates the display image data based on the orientation of the still image data and the orientation of the display apparatus 100. Since both the designated still image data and the display apparatus 100 are portrait-oriented, the orientation of the still image to be displayed is not changed. The number of pixels (the size) of the still image data readout is changed according to the number of pixels of the display unit 106, to generate the display image data.

The display image data generated in this way is sent to the display control unit 105, and an image is displayed on the display unit 106. In step S705, the control unit 101 determines whether the user operates the operation unit 104 while the image is being displayed, to issue an instruction for switching to the subsequent image.

If the instruction for switching is issued (YES in step S705), then in step S708, the control unit 101 designates, out of the still images included in the portrait-oriented image list, the subsequent still image. Then, the processing returns to step S703. In step S708, the last still image in the portrait-oriented image list is designated, and the first still image is then designated. If the instruction for switching is not issued (NO in step S705), then in step S706, the control unit 101 determines whether the orientation of the display apparatus 100 is changed.

If the orientation of the display apparatus 100 is changed (YES in step S706), the processing returns to step S701 because a still image included in the landscape-oriented image list is displayed at this time. If the orientation of the display apparatus 100 is not changed (NO in step S706), then in step S707, the control unit 101 determines whether the user operates the operation unit 104, to issue an instruction to switch the display mode to any one of the other display modes, i.e., the normal display mode, the list display mode, and the slide show mode. If the instruction to switch the display mode is issued (YES in step S707), the processing exits the flow illustrated in FIG. 7.

If the display apparatus 100 is landscape-oriented in step S701, then in step S709, the control unit 101 determines whether still images are included in the landscape-oriented image list stored in the memory 108. If no still image is included in the list (NO in step S709), then in step S716, the control unit 101 displays on the display unit 106 a warning screen indicating that a landscape-oriented still image is not stored and cannot be displayed.

If the still images are included in the landscape-oriented image list stored in the memory 108 (YES in step S709), then in step S710, the control unit 101 designates the first still image from the landscape-oriented image list. In step S711, the control unit 101 causes the reading unit 102 to read out the designated still image data from the storage medium M, and causes the image processing unit 103 to generate display image data.

The image processing unit 103 generates the display image data based on the orientation of the still image data and the orientation of the display apparatus 100. Since both the designated still image data and the display apparatus 100 are landscape-oriented, the orientation of the still image to be displayed is not changed. The number of pixels (the size) of the still image data readout is changed according to the number of pixels of the display unit 106, to generate the display image data.

The display image data generated in this way is sent to the display control unit 105, and an image is displayed on the display unit 106. In step S712, the control unit 101 determines whether the user operates the operation unit 104 while the image is being displayed, to issue an instruction for switching to the subsequent image.

If the instruction for switching is issued (YES in step S712), then in step S715, the control unit 101 designates, out of the still images included in the landscape-oriented image list, the subsequent still image. Then, the processing returns to step S711. If the instruction for switching is not issued (NO in step S712), then in step S713, the control unit 101 determines whether the orientation of the display apparatus 100 is changed.

If the orientation of the display apparatus 100 is changed (YES in step 713), the processing returns to step S701 because a still image included in the portrait-oriented image list is displayed at this time. If the orientation of the display apparatus 100 is not changed (NO in step S713), then in step S714, the control unit 101 determines whether the user operates the operation unit 104, to issue an instruction to switch the display mode to any one of the other display modes, i.e., the normal display mode, the list display mode, and the slide show mode. If the instruction to switch the display mode is issued (YES in step S714), the processing exits the flow illustrated in FIG. 7.

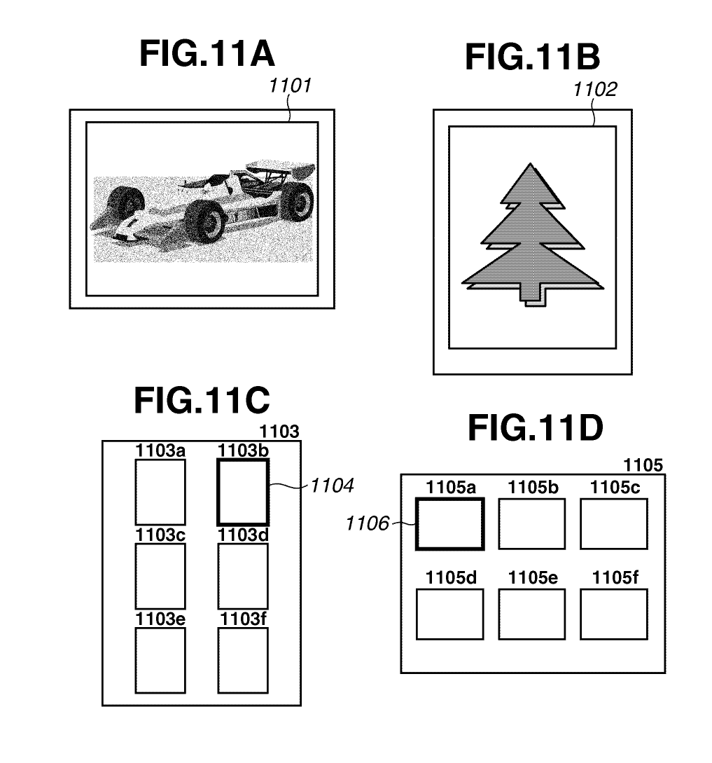

FIGS. 11A to 11D show how an image is displayed by the single display mode processing in the switching display mode. FIG. 11A illustrates a landscape-oriented image 1101 displayed when the display apparatus 100 is landscape-oriented, and FIG. 11B illustrates a portrait-oriented image 1102 displayed when the display apparatus 100 is portrait-oriented.

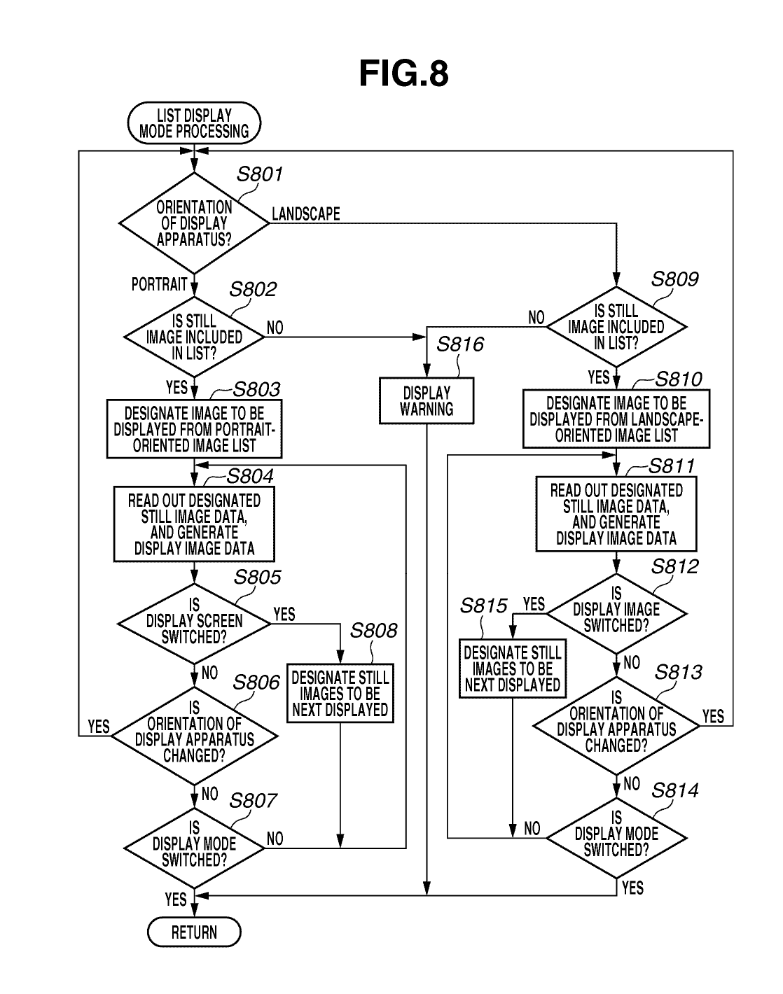

FIG. 8 is a flowchart illustrating the list display mode processing in step S606.

In step S801, the control unit 101 first detects the orientation of the display apparatus 100. If the display apparatus 100 is portrait-oriented, then in step S802, the control unit 101 determines whether still images are included in the portrait-oriented image list stored in the memory 108. If no still image is included in the list (NO in step S802), then in step S816, the control unit 101 displays on the display unit 106 a warning screen indicating that a portrait-oriented still image is not stored and cannot be displayed.

If the still images are included in the portrait-oriented image list stored in the memory 108 (YES in step S802), then in step S803, the control unit 101 designates the still image to be displayed from the portrait-oriented image list according to an order included in the list. Reduced images of six images are displayed on one list display screen.

In step S804, the control unit 101 causes the reading unit 102 to read out the designated still image data from the storage medium M, and causes the image processing unit 103 to generate display image data. The image processing unit 103 generates the display image data based on the orientation of the sill image data and the orientation of the display apparatus 100. A cursor for selecting one of the reduced images, together with the reduced images, is displayed. Since both the designated still image data and the display apparatus 100 are portrait-oriented, the orientation of the still image to be displayed is not changed. The size of the still image data read out is changed according to the size (the number of pixels) of the list display screen, to generate list display image data.

The list display image data generated in this way is sent to the display control unit 105, and an image is displayed on the display unit 106. In step S805, the control unit 101 determines whether the user operates the operation unit 104 while the image is being displayed, to issue an instruction to switch a display screen.

If the instruction to switch the display screen is issued (YES in step S805), then in step S808, the control unit 101 designates, out of the still images included in the portrait-oriented image list, the six still images to be next displayed. Then, the processing returns to step S804. If the instruction to switch the display screen is not issued (NO in step S805), then in step S806, the control unit 101 determines whether the orientation of the display apparatus 100 is changed.

If the orientation of the display apparatus 100 is changed (YES in step S806), the processing returns to step S801 because a still image included in the landscape-oriented image list is displayed at this time. If the orientation of the display apparatus 100 is not changed (NO in step S806), then in step S807, the control unit 101 determines whether the user operates the operation unit 104, to issue an instruction to switch the display mode to any one of the other display mode, i.e., the normal display mode, the single display mode, and the slide show mode. If the instruction to switch the display mode is issued (YES in step S807), the processing exits the flow illustrated in FIG. 8.

If the display apparatus 100 is landscape-oriented in step S801, then in step S809, the control unit 101 determines whether still images are included in the landscape-oriented image list stored in the memory 108. If no still image is included in the list (NO in step S809), then in step S816, the control unit 101 displays on the display unit 106 a warning screen indicating that a landscape-oriented still image is not stored and cannot be displayed. Then, the processing exits the flow illustrated in FIG. 8.

If the still images are included in the landscape-oriented image list stored in the memory 108 (YES in step S809), then in step S810, the control unit 101 designates the still image to be displayed according to the landscape-oriented image list. In step S811, the control unit 101 causes the reading unit 102 to readout the designated still image data from the storage medium M, and causes the image processing unit 103 to generate display image data.

The image processing unit 103 generates the display image data based on the orientation of the still image data and the orientation of the display apparatus 100. A cursor for selecting one of the reduced images, together with the reduced images, is displayed. Since both the designated still image data and the display apparatus 100 are landscape-oriented, the orientation of the still image to be displayed is not changed. The size of the still image data read out is changed according to the size (the number of pixels) of the list display screen, to generate list display image data.

The list display image data generated in this way is sent to the display control unit 105, and an image is displayed on the display unit 106. In step S812, the control unit 101 determines whether the user operates the operation unit 104 while the image is being displayed, to issue an instruction for switching to the subsequent display screen.

If the instruction for switching is issued (YES in step S812), then in step S815, the control unit 101 designates, out of the still images included in the landscape-oriented image list, the six still images to be next displayed. Then, the processing returns to step S811. If the instruction for switching is not issued (NO in step S812), then in step S813, the control unit 101 determines whether the orientation of the display apparatus 100 is changed.

If the orientation of the display apparatus 100 is changed (YES in step S813), the processing returns to step S801 because a still image included in the portrait-oriented image list is displayed at this time. If the orientation of the display apparatus 100 is not changed (NO in step S813), then in step S814, the control unit 101 determines whether the user operates the operation unit 104, to issue an instruction to switch the display mode to any one of the other display mode, i.e., the normal display mode, the list display mode, and the slide show mode. If the instruction to switch the display mode is issued (YES in step S814), the processing exits the flow illustrated in FIG. 8.

FIG. 11C illustrates how a list display screen 1103 is displayed in the switching display mode when the display apparatus 100 is portrait-oriented. As illustrated in FIG. 11C, six portrait-oriented reduced images 1103a to 1103f are displayed on the list display screen 1103. In the switching display mode, when the display apparatus 100 is portrait-oriented, a portrait-oriented image is automatically retrieved and displayed.

A cursor 1104 is displayed for the user selecting one of the reduced images. When the user operates the operation unit 104 to move the cursor 1104, to select one of the reduced images, and issues an instruction for reproduction in the state, the display mode is switched to the signal display mode. As illustrated in FIG. 11B, the selected portrait-oriented image is displayed in the single display mode.

FIG. 11D illustrates how a list display screen 1105 is displayed in the switching display mode when the display apparatus 100 is landscape-oriented. As illustrated in FIG. 11D, six portrait-oriented reduced images 1105a to 1105f are displayed on the list display screen 1105. In the switching display mode, when the display apparatus 100 is landscape-oriented, a landscape-oriented image is automatically retrieved and displayed.

A cursor 1106 is displayed for the user selecting one of the reduced images. When the user operates the operation unit 104 to move the cursor 1106, to select one of the reduced images, and issues an instruction for reproduction in the state, the display mode is switched to the signal display mode. As illustrated in FIG. 11A, the selected landscape-oriented image is displayed in the single display mode.

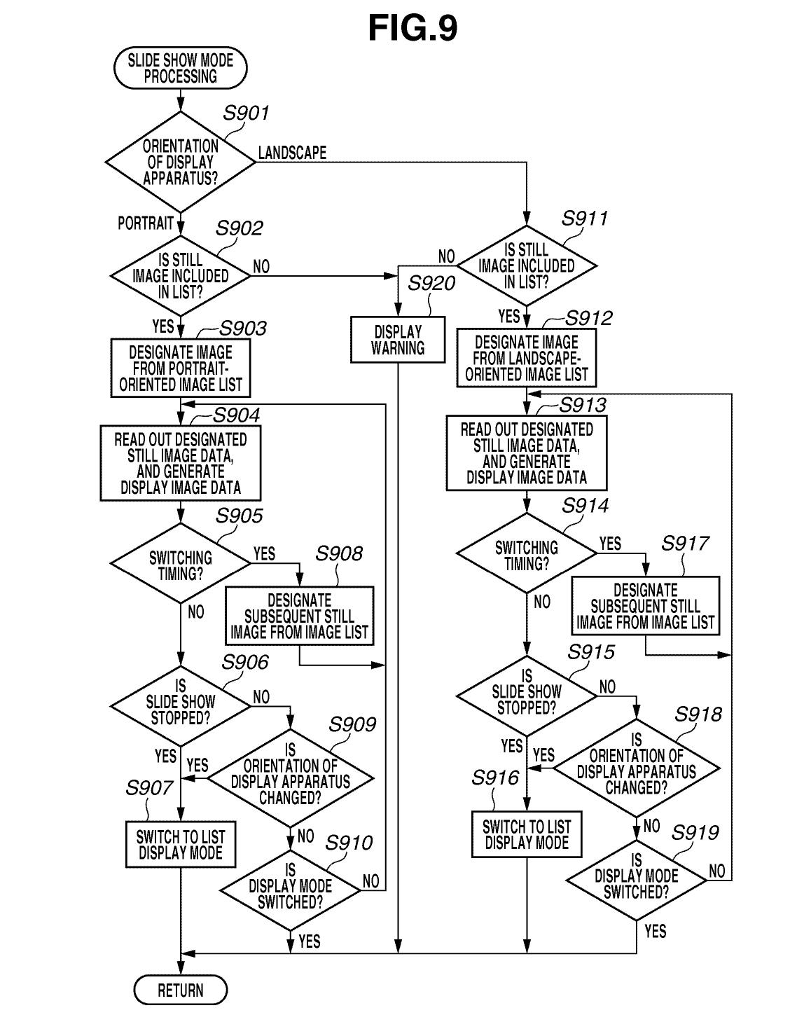

The slide show mode will be then described. FIG. 9 is a flowchart illustrating the slide show mode processing in step S607.

In step S901, the control unit 101 first detects the orientation of the display apparatus 100. If the display apparatus 100 is portrait-oriented, then in step S902, the control unit 101 determines whether still images are included in the portrait-oriented image list stored in the memory 108. If no still image is included in the list (NO in step S902), then in step S920, the control unit 101 displays on the display unit 106 a warning screen indicating that a portrait-oriented still image is not stored and cannot be displayed. Then, the processing exits the flow illustrated in FIG. 9.

If the still images are included in the portrait-oriented image list stored in the memory 108 (YES in step S902), then in step S903, the control unit 101 designates the still image to be displayed from the portrait-oriented image list. The still image designated at this time is the same as in the single display mode.

In step S904, the control unit 101 causes the reading unit 102 to read out the designated still image data from the storage medium M, and causes the image processing unit 103 to generate display image data.

The image processing unit 103 generates the display image data based on the orientation of the still image data and the orientation of the display apparatus 100. Since both the designated still image data and the display apparatus 100 are portrait-oriented, the orientation of the still image to be displayed is not changed. The size of the still image data read out is changed according to the size (the number of pixels) of the display unit 106, to generate the display image data.

In the slide show mode, an image to be displayed is automatically switched for each elapse of a predetermined period of time. After the first image is displayed, therefore, a self-contained counter is operated, to count the period of time elapsed since the image was displayed. In step S905, the control unit 101 determines whether timing of switching a display image is generated based on the value of the counter.

If the timing of switching a display image is generated (YES in step S905), then in step S908, the control unit 101 designates the subsequent still image from the portrait-oriented image list. Then, the processing returns to step S904. If the timing of switching a display image is not generated (NO in step S905), then in step S906, the control unit 101 determines whether an instruction to stop a slide show is issued.

If the instruction to stop the slide show is issued (YES in step S906), then in step S907, the control unit 101 stops the slide show and switches the display mode to the list display mode. Then, the processing exits the flow illustrated in FIG. 9. If the instruction to stop the slide show is not issued (NO in step S906), then in step S909, the control unit 101 determines whether the orientation of the display apparatus 100 is changed during the slide show mode.

If the orientation of the display apparatus 100 is changed (YES in step S909), then in step S907, the control unit 101 stops the slide show and switches the display mode to the list display mode. Then, the processing exits the flow illustrated in FIG. 9. If the orientation of the display apparatus 100 is not changed (NO in step S909), then in step S910, the control unit 101 determines whether the user operates the operation unit 104, to issue an instruction to switch the display mode.

If the instruction to switch the display mode is not issued (NO in step S910), the processing returns to step S904. If the instruction to switch the display mode is issued (YES in step S910), the processing exits the flow illustrated in FIG. 9.

If the display apparatus 100 is landscape-oriented in step S901, then in step S911, the control unit 101 determines whether still images are included in the landscape-oriented image list stored in the memory 108. If no still image is included in the list (NO in step S911), then in step S920, the control unit 101 displays on the display unit 106 a warning screen indicating that a landscape-oriented still image is not stored and cannot be displayed. Then, the processing exits the flow illustrated in FIG. 9.

If the still images are included in the landscape-oriented image list stored in the memory 108 (YES in step S911), then in step S912, the control unit 101 designates the still image to be displayed from the landscape-oriented image list. In step S913, the control unit 101 causes the reading unit 102 to read out the designated still image data from the storage medium M, and causes the image processing unit 103 to generate display image data.

The image processing unit 103 generates the display image data based on the orientation of the still image data and the orientation of the display apparatus 100. Since both the designated still image data and the display apparatus 100 are landscape-oriented, the orientation of the still image to be displayed is not changed. The size of the still image data read out is changed according to the size (the number of pixels) of the display unit 106, to generate the display image data. In step S914, the control unit 101 determines whether timing of switching a display image is generated.

If the timing of switching a display image is generated (YES in step S914), then in step S917, the control unit 101 designates the subsequent still image from the landscape-oriented image list. Then, the processing returns to step S913. If the timing of switching a display image is not generated (NO in step S914), then in step S915, the control unit 101 determines whether an instruction to stop a slide show is issued. If the instruction to stop the slide show is issued (YES in step S915), then in step S916, the control unit 101 stops the slide show and switches the display mode to the list display mode. Then, the processing exits the flow illustrated in FIG. 9.

If the instruction to stop the slide show is not issued (NO in step S915), then in step S918, the control unit 101 determines whether the orientation of the display apparatus 100 is changed during the slide show mode.

If the orientation of the display apparatus 100 is changed (YES in step S918), then in step S916, the control unit 101 stops the slide show and switches the display mode to the list display mode. Then, the processing exits the flow illustrated in FIG. 9. If the orientation of the display apparatus 100 is not changed (NO in step S918), then in step S919, the control unit 101 determines whether the user operates the operation unit 104, to issue an instruction to switch the display mode.

If the instruction to switch the display mode is not issued (NO in step S919), the processing returns to step S913. If the instruction to switch the display mode is issued (YES in step S919), the processing exits the flow illustrated in FIG. 9.

In the present exemplary embodiment, in the normal display mode, the control unit 101 thus displays an image to be displayed with the size thereof changed according to the orientation of the display apparatus and the orientation of the image to be displayed.

On the other hand, in the switching display mode, the control unit 101 automatically selects or retrieves, out of images stored in the storage medium M, the image oriented according to the orientation of the display apparatus, and displays the selected or retrieved image. If the display apparatus is landscape-oriented, for example, a landscape-oriented image is retrieved and displayed.

Therefore, the user can simply retrieve and display an image in the same orientation as the orientation of the display apparatus.

In the present exemplary embodiment, in the switching display mode, an image in the portrait-oriented image list is displayed when the display apparatus is portrait-oriented, and an image in the landscape-oriented image list is displayed when the display apparatus is landscape-oriented. Even if the display apparatus is portrait-oriented, for example, the user may be able to display an image in the landscape-oriented image list.

More specifically, when the operation unit is provided with a switch for issuing an instruction for portrait/landscape switching, to issue an instruction for portrait/landscape switching while a portrait-oriented image is being displayed, an image in the landscape-oriented image list may be displayed with the display apparatus portrait-oriented. In addition thereto, an icon for portrait/landscape switching is displayed on apart of a single display screen, a list display screen, or a slide show screen, the user selects the icon, to issue an instruction for display so that an image in an orientation different from an image that is being displayed may be displayed.

When the icon for portrait/landscape switching is displayed on a list display screen of portrait-oriented images, and the icon is selected, an image in the landscape-oriented image list may be displayed with the display apparatus portrait-oriented.

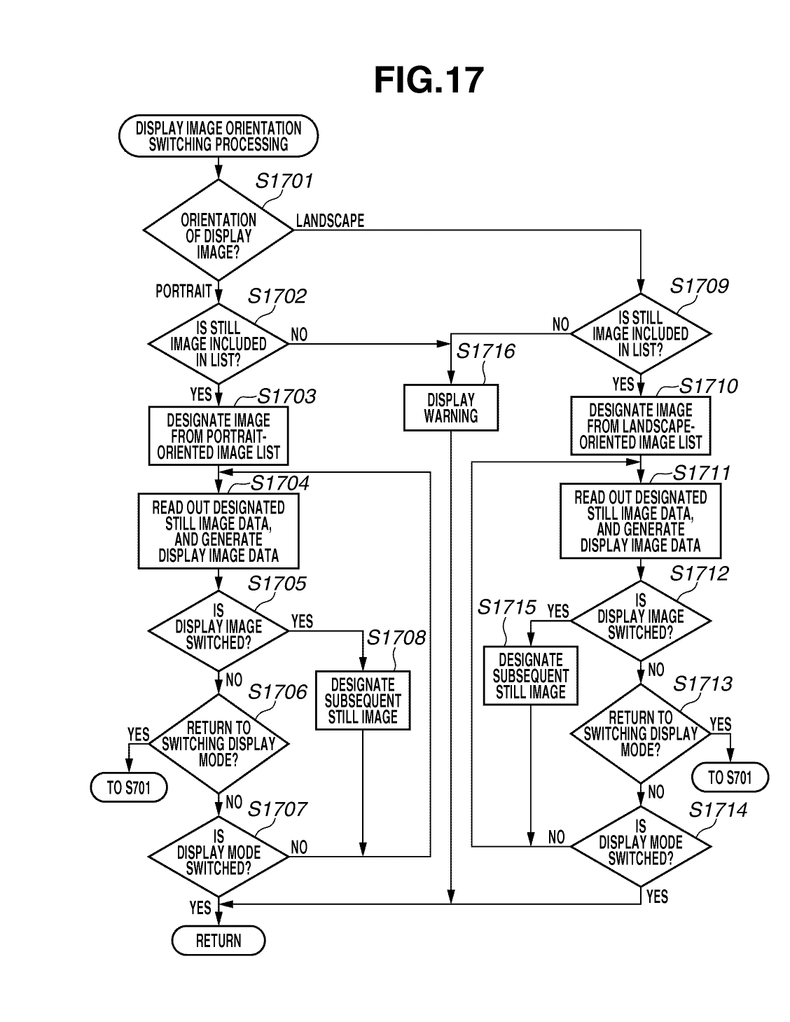

FIG. 17 is a flowchart illustrating processing performed when an instruction to switch the orientation of a display image while a single display screen is being displayed in the switching display mode. Processing illustrated in FIG. 17 is performed by the control unit 104 controlling each of the units.

If an instruction to switch the orientation of a display image is issued while the single display mode illustrated in FIG. 7 is being executed, the processing is started.

In step S1701, the control unit 101 detects the orientation of a display image after the switching. If the display image is portrait-oriented, then in step S1702, the control unit 101 determines whether still images are included in the portrait-oriented image list stored in the memory 108. If no still image is included in the list (NO in step S1702), then in step S1716, the control unit 101 displays on the display unit 106 a warning screen indicating that a portrait-oriented still image is not stored and cannot be displayed. Then, the processing exits the flow illustrated in FIG. 17.

If the still images are included in the portrait-oriented image list (YES in step S1702), then in step S1703, the control unit 101 designates the still image to be displayed from the portrait-oriented image list. In step S1704, the control unit 101 causes the reading unit 102 to read out the designated still image data from the storage medium M, and causes the image processing unit 103 to generate display image data.

The image processing unit 103 generates the display image data based on the orientation of the still image data and the orientation of the display apparatus 100. Since the designated still image data is portrait-oriented and the display apparatus 100 is landscape-oriented, the orientation of the still image to be displayed is changed. Furthermore, the number of pixels (the size) of the still image data read out is changed according to the number of pixels of the display unit 106, to generate the display image data.

The display image data generated in this way is sent to the display control unit 105, and an image is displayed on the display unit 106. In step S1705, the control unit 101 determines whether the user operates the operation unit 104 while the image is being displayed, to issue an instruction for switching to the subsequent image.

If the instruction for switching is issued (YES in step S1705), then in step S1708, the control unit 101 designates, out of the still images included in the portrait-oriented image list, the subsequent still image. Then, the processing returns to step S1703. If the instruction for switching is not issued (NO in step S1705), then in step S1706, the control unit 101 determines whether an instruction to return to the switching display mode is issued. In the present exemplary embodiment, the display mode can be returned to the switching display mode by changing the orientation of the display apparatus 100 or operating the operation unit 104.

If the instruction to return to the switching display mode is issued (YES in step S1706), the processing returns to step S701 illustrated in FIG. 7. If the instruction to return to the switching display mode is not issued (NO in step S1706), then in step S1707, the control unit 101 determines whether the user operates the operation unit 104, to issue an instruction to switch the display mode to any one of the other display mode, i.e., the normal display mode, the list display mode, and the slide show mode. If the instruction to switch the display mode is issued (YES in step S1707), the processing exits the flow illustrated in FIG. 17.

If the display image is landscape-oriented, then in step S1701, the control unit 101 determines whether still images are included in the landscape-oriented image list stored in the memory 108. If no still image is included in the list (NO in step S1709), then in step S1716, the control unit 101 displays on the display unit 106 a warning screen indicating that a landscape-oriented still image is not stored and cannot be displayed. Then, the processing exits the flow illustrated in FIG. 17.

If the still images are included in the landscape-oriented image list stored in the memory 108 (YES in step S1709), then in step S1710, the first still image is designated from the landscape-oriented image list. In step S1711, the control unit 101 causes the reading unit 102 to read out the designated still image data from the storage medium M, and causes the image processing unit 103 to generate display image data.

The image processing unit 103 generates the display image data based on the orientation of the still image data and the orientation of the display apparatus 100. Since the designated still image data is landscape-oriented and the display apparatus 100 is portrait-oriented, the orientation of the still image to be displayed is changed. Furthermore, the number of pixels (the size) of the still image data read out is changed according to the number of pixels of the display unit 106, to generate the display image data.

The display image data generated in this way is sent to the display control unit 105, and an image is displayed on the display unit 106. In step S1712, the control unit 101 determines whether the user operates the operation unit 104 while the image is being displayed, to issue an instruction for switching to the subsequent image.

If the instruction for switching is issued (YES in step S1712), then in step S1715, the control unit 101 designates, out of the still images included in the portrait-oriented image list, the subsequent still image. Then, the processing returns to step S1711. If the instruction for switching is not issued (NO in step S1712), then in step S1713, the control unit 101 determines whether an instruction to return to the switching display mode is issued. If the instruction to return to the switching display mode is issued (YES in step S1713), the processing returns to step S701 illustrated in FIG. 7.

If the instruction to return to the switching display mode is not issued (NO in step S1713), then in step S1714, the control unit 101 determines whether an instruction to switch the display mode to any one of the other display mode, i.e., the normal display mode, the list display mode, and the slide show mode. If the instruction to switch the display mode (YES in step S1714), the processing exits the flow illustrated in FIG. 17.

Although in the present exemplary embodiment, the image data is read out of the storage medium M and displayed, the image data designated by the user out of the image data stored in the storage medium M may be stored in the memory 108. The image data stored in the memory 108 is stored after the power to the apparatus is turned off, and is read out of the memory 108 and displayed even if the storage medium M is not mounted. At that time, the orientation of each of the image data stored in the memory 108 may be detected to previously generate the portrait-oriented image list and the landscape-oriented image list.

This enables the image data oriented according to the orientation of the display apparatus 100 to be read out of the memory 108 and displayed, as when the image data is read out of the storage medium M and displayed.

A second exemplary embodiment will be then described.

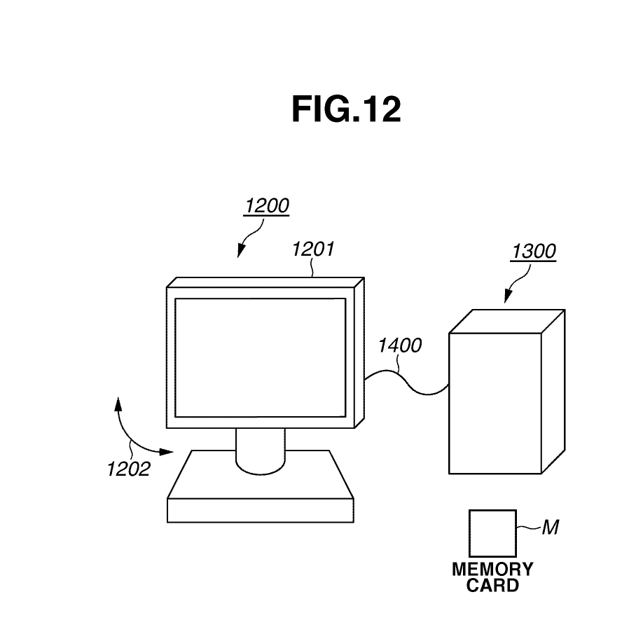

FIG. 12 illustrates the configuration of a display system in the second exemplary embodiment of the present invention. The display system illustrated in FIG. 12 includes a display apparatus 1200 and a display control apparatus 1300. The display apparatus 1200 and the display control apparatus 1300 are connected to each other via a high-definition multimedia interface (HDMI) cable 1400. The display apparatus 1200 displays an image relating to display image data sent from the display control apparatus 1300. A display unit 1201 in the display apparatus 1200 can rotate through 90 degrees in a direction indicated by an arrow 1202 around an axis (not illustrated) at its center. This enables a user to change the orientation of the display unit 1201 to either one of a landscape orientation and a portrait orientation.

The display control apparatus 1300 sends the display image data to the display apparatus 1200 via the HDMI cable 1400, to control a display operation. The display control apparatus 1300 reads out image data stored in a memory card M, and generates display image data, as described below, using the image data read out.

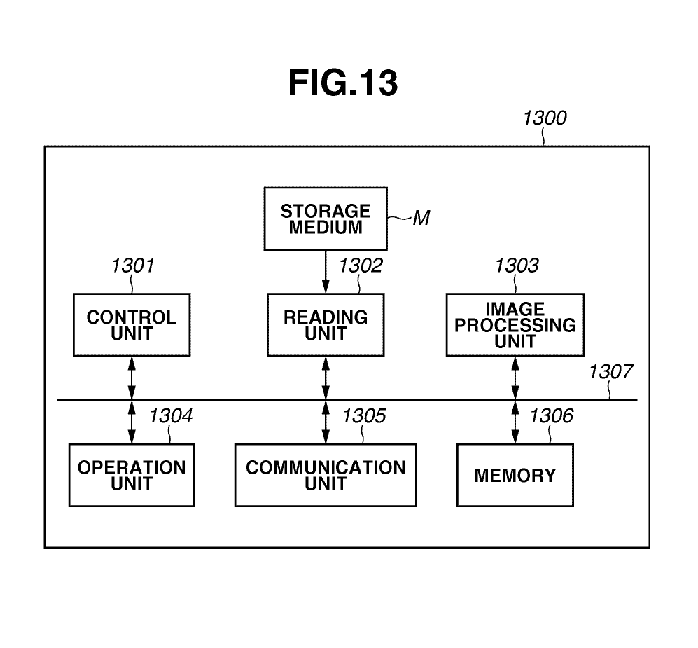

FIG. 13 is a functional block diagram illustrating the internal configuration of the display control apparatus 1300.

In FIG. 13, a control unit 1301 controls the operation of the display control apparatus 1300. A reading unit 1302 reads out still image data and moving image data from a storage medium M such as a memory card. Although in the present exemplary embodiment, processing performed when the still image data is read out of the storage medium M and displayed will be described, the moving image data can be similarly displayed. An image processing unit 1303 includes a decoder for decoding the image data read out of the storage medium M and increasing the amount of information. The image processing unit 1303 performs various types of image processing such as processing for changing the size of the decoded image data.

An operation unit 1304 includes various types of operation switches such as a power switch, a mode switch for switching a mode, and a switch for switching an image to be displayed. In the present exemplary embodiment, the display control apparatus 1300 includes a remote controller for operating the display control apparatus 1300. The operation unit 1304 includes the remote controller and a receiving unit for receiving a command from the remote controller. A communication unit 1305 is connected to the display apparatus 1200 via the HDMI cable 1400, and communicates information such as image data from/to the display apparatus 1200.

A memory 1306 includes a semiconductor memory such as a flush memory and a hard disk, and stores the image data read out of the storage medium M. The control unit 1301 stores various types of information in the memory 1306. Various types of data are sent and received via a data bus 1307 among blocks.

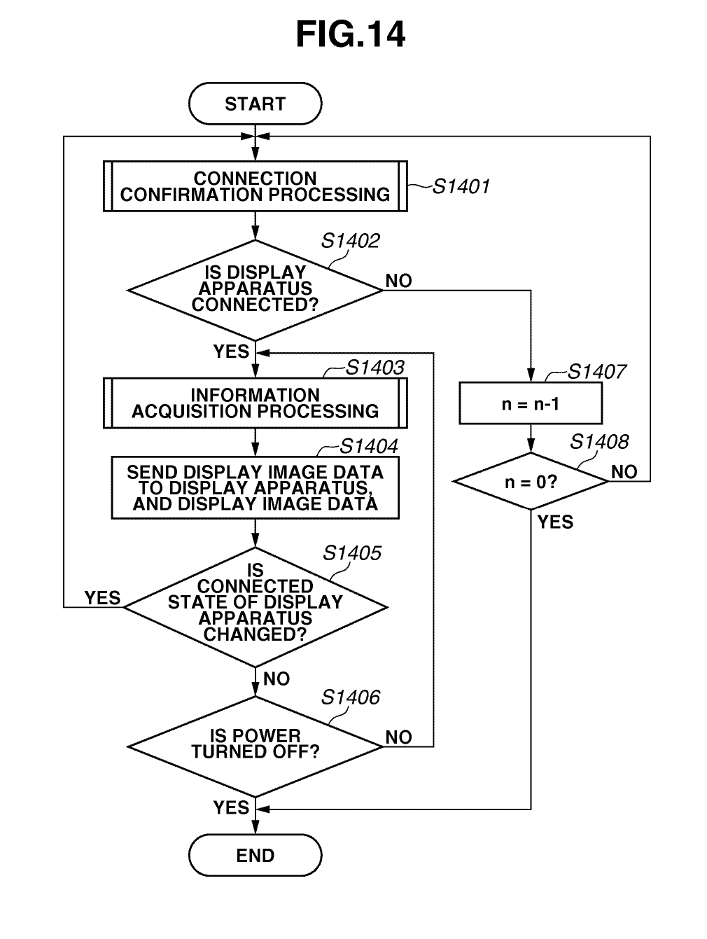

The operation of the display control apparatus 1300 will be then described. FIG. 14 is a flowchart illustrating the operation of the display control apparatus 1300. Processing illustrated in FIG. 14 is performed by the control unit 1301 controlling each of the units.

When the operation unit 1304 turns the power on, the processing is started. In step S1401, the control unit 1301 first inquires of the communication unit 1305 whether the display apparatus 1200 is connected, to perform connection confirmation processing. In step S1402, the control unit 1301 determines whether the display apparatus 1200 is connected as a result of the connection confirmation processing. If the display apparatus 1200 is not connected (NO in step S1402), then in step S1407, a counter value n stored in the memory 1306 is reduced by one. The control unit 1301 sets a predetermined value in the counter value n when the power is turned on. In step S1408, the control unit 1301 determines whether the counter value n becomes zero. If the counter value becomes zero (YES in step S1408), the processing is terminated. If the counter value n is not zero (NO in step S1408), the control unit 1301 confirms the presence or absence of connection for the communication unit 1305 again after an elapse of a predetermined period of time.

If the display apparatus 1200 is connected as a result of the connection confirmation processing (YES in step S1402), then in step S1403, the control unit 1301 returns the counter value n to an initial value, to perform device information acquisition processing for acquiring device information relating to the display apparatus 1200. In step S1404, the control unit 1301 sends display image data generated as described below to the display apparatus 1200 via the communication unit 1305 and displays image data thereon after acquiring the device information relating to the display apparatus 1200.

In step S1405, the control unit 1301 then determines whether the connected state of the display apparatus 1200 is changed. If the connected state of the display apparatus 1200 is changed (YES in step S1405), the processing returns to step S1401. In step S1401, the connection confirmation processing of the display apparatus 1200 is performed again. If the connection is confirmed, the control unit 1301 acquires the device information relating to the connected display apparatus 1200 again.

If the connected state of the display apparatus 1200 is not changed (NO in step S1405), then in step S1406, the control unit 1301 determines whether the operation unit 1304 issues an instruction to turn the power off. If the instruction to turn the power off is not issued (NO in step S1406), the processing returns to step S1403. In step S1403, the processing is continued. If the instruction to turn the power off is issued (YES in step S1406), the processing is terminated.

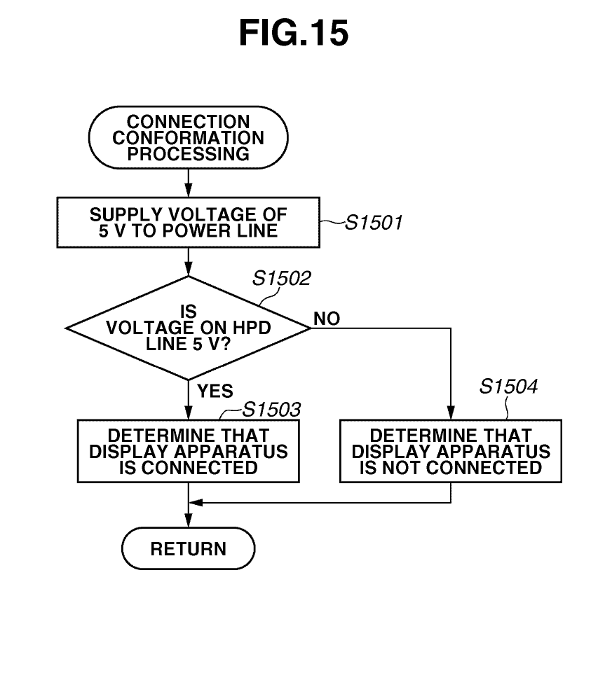

The connection confirmation processing in step S1401 will be then described with reference to FIG. 15.

In step S1501, the control unit 1301 first supplies power to a power line of the HDMI interface via the communication unit 1305 such that a voltage on the power line becomes 5 volts. In step S1502, the control unit 1301 then confirms whether a voltage on a hot plug detect (HPD) line of the HDMI interface is 5 volts representing a connection response signal from the display apparatus 1200. If the control unit 1301 detects that the voltage on the HPD line is 5 volts (YES in step S1502), then in step S1503, the communication unit 1505 determines that the display apparatus 1200 is connected to the exterior, and notifies the control unit 1301 of the determination. If the control unit 1301 detects that the voltage on the HPD line is zero volts (NO in step S1502), then in step S1504, the communication unit 1503 determines that the display apparatus 1200 is not connected to the exterior.

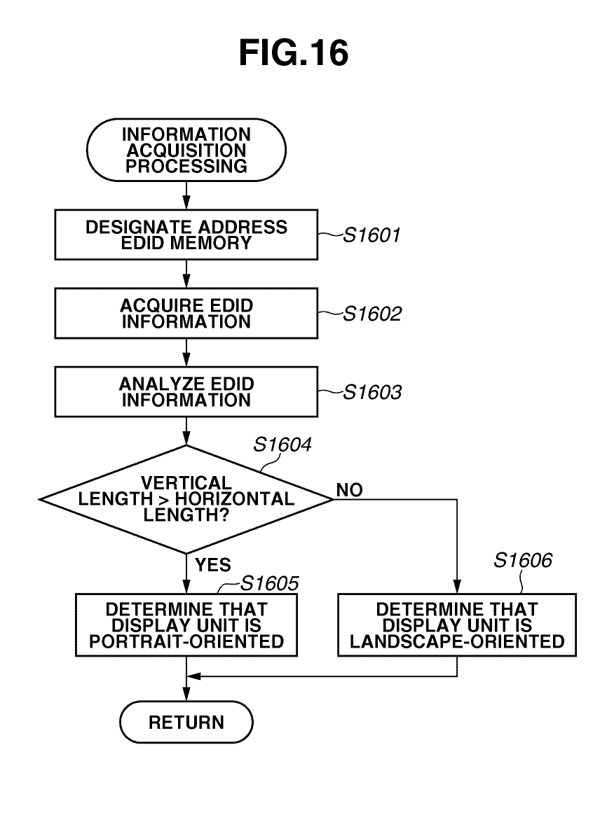

The device information acquisition processing in step S1403 will be then described with reference to FIG. 16.

In step S1601, the control unit 1301 first designates an address assigned to initial reading data in an extended display identification data (EDID) memory for the communication unit 1305, to start to acquire EDID memory information. In step S1602, the communication unit 1305 uses an address designated from the control unit 1301, to send a request to acquire the EDID memory information in the display apparatus 1200 and receive the EDID memory information. The received EDID memory information is stored in the memory 1306.

In step S1603, the control unit 1301 analyses the received EDID memory information. In step S1604, the control unit 1301 determines the portrait/landscape orientation of the display unit 1201 in the display apparatus 1200. More specifically, the portrait/landscape orientation of the display unit 1201 is determined depending on which of the vertical length and horizontal length in a screen display size, which exists in the EDID memory information, is greater using information representing the screen display size. If the vertical length is greater than the horizontal length (YES in step S1604), then in step S1605, the control unit 1301 determines that the display unit 1201 in the display apparatus 1200 is portrait-oriented. On the other hand, if the vertical length is smaller than the horizontal length (NO in step S1604), then in step S1606, the control unit 1301 determines that the display unit 1201 is landscape-oriented.

In the present exemplary embodiment, in the display apparatus 1200, the information representing the screen display size in the EDID memory information is rewritten every time the orientation of the display unit 1201 is changed. If the display unit 1201 is landscape-oriented and is composed of n pixels in the vertical direction and m pixels in the longitudinal direction (m>n), for example, the EDID memory information is written as “vertical n×horizontal m”. On the other hand, the display unit 1201 is portrait-oriented, the EDID memory information is rewritten as “vertical m×horizontal n”. The display apparatus 1200 changes the voltage on the HPD line from 5 volts to zero volts once and returns to 5 volts again every time the orientation of the display unit 1201 is changed.

This enables the device information acquisition processing to be performed every time the orientation of the display unit 1201 is changed while the display apparatus 1200 is being connected in the display control apparatus 1300, to determine the orientation of the display unit 1201. More specifically, if the voltage on the HPD line becomes zero volts, the connection unit 1301 determines that the connected state is changed (YES in step S1405). Then, the processing returns to step S1401.

Although in the present exemplary embodiment, the portrait/landscape orientation of the display unit 1201 in the connected display apparatus 1200 is determined based on the information representing the screen display size in the EDID memory information, the present invention is not limited to that. The display control apparatus 1300 may be notified of the portrait/landscape orientation using a vendor-dependent area and an expanded area in the EDID memory information, for example.

If the orientation of the display unit 1201 in the display apparatus 1200 is detected in this way, a display screen is generated according to the orientation of the display unit 1201. The processing for generating the display screen is similar to the processing in the first exemplary embodiment illustrated in FIG. 4 and hence, the detailed description is omitted. In the present exemplary embodiment, the display apparatus 1200 has a normal display mode and a switching display mode. In the normal display mode, a display screen is generated according to the orientation of the display unit 1201, as illustrated in FIG. 5. In the switching display mode, the image oriented according to the orientation of the display unit 1201 is read out of the memory card M and displayed, as needed, as illustrated in FIGS. 6 to 9.

In the present exemplary embodiment, in the normal display mode, an image to be displayed is displayed with the size thereof changed according to the portrait/landscape orientation of the display unit in the display apparatus connected to the exterior and the orientation of the image.

On the other hand, in the switching display mode, the image oriented according to the orientation of the display apparatus out of the images stored in the storage medium is automatically selected or retrieved and displayed. When the display unit in the display apparatus is landscape-oriented, for example, the landscape-oriented image is retrieved and displayed.

Therefore, the user can simply retrieve and display the image in the same orientation as the orientation of the display unit.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Applications No. 2009-039619 filed Feb. 23, 2009 and No. 2010-010942 filed Jan. 21, 2010, which are hereby incorporated by reference herein in their entirety.

What is claimed is:

1. An apparatus comprising:
a detection unit configured to detect portrait/landscape orientation of the apparatus;
a retrieval unit configured to retrieve, out of a plurality of image data, image data oriented according to the detected orientation;
a display unit; and
a control unit configured to display on the display unit an image relating to the retrieved image data.

2. The apparatus according to claim 1, wherein the control unit changes an image to be displayed if the detection unit detects that the orientation of the apparatus is changed.

3. The apparatus according to claim 1, wherein the control unit displays an image relating to one of a retrieved plurality of image data, and displays an image relating to another one of the retrieved plurality of image data if an instruction to switch the image to be displayed is issued.

4. The apparatus according to claim 1, wherein the control unit displays a list of reduced images relating to the plurality of image data in the same retrieved orientation.

5. The apparatus according to claim 1, wherein the retrieval unit generates a portrait-oriented list including portrait-oriented image data and a landscape-oriented list including landscape-oriented image data, and the control unit displays an image relating image data designated in the portrait-oriented list if the apparatus is portrait-oriented, and displays an image relating to image data designated in the landscape-oriented list if the apparatus is landscape-oriented.

6. The apparatus according to claim 5, wherein the control unit displays an image relating to image data designated in the portrait-oriented list if an instruction to switch the orientation of the image is issued when an image relating to image data designated in the landscape-oriented list is displayed on the apparatus.

7. The apparatus according to claim 1, wherein the control unit displays, if the detection unit detects that the orientation of the apparatus is changed, an image in an orientation different from the orientation of an image that has been being displayed before the orientation is changed.

8. The apparatus according to claim 1, wherein the control unit displays, if the apparatus is landscape-oriented when a portrait-oriented image is being displayed, a landscape-oriented image in place of the portrait-oriented image, and displays, if the apparatus is portrait-oriented when a landscape-oriented image is being displayed, a portrait-oriented image in place of the landscape-oriented image.

9. The apparatus according to claim. 1, further comprising a setting unit configured to set a display mode for displaying an image in an orientation different from an orientation of the image that is being displayed when the orientation of the apparatus is changed and a display mode for displaying an image that is being displayed without changing the image even if the orientation of the apparatus is changed.

10. A display apparatus comprising:
a detection unit configured to detect portrait/landscape orientation of the apparatus;
a classification unit configured to classify a plurality of image data into portrait-oriented image data and landscape-oriented image data;
a display unit; and
a control unit configured to select one of the portrait-oriented and landscape-oriented image data obtained by the classification unit according to the orientation detected by the detection unit, and to display an image relating to the selected image data on the display unit.

11. The apparatus according to claim 10, wherein the control unit selects the portrait-oriented image data if detection unit detects that the display apparatus is portrait-oriented, and selects the landscape-oriented image data if the detection unit detects that the apparatus is landscape-oriented.

12. The apparatus according to claim 10, wherein the control unit selects the landscape-oriented image data if the apparatus is landscape-oriented when a portrait-oriented image is being displayed, to display an image relating to the selected landscape-oriented image data in place of the portrait-oriented image, and selects the portrait-oriented image data if the apparatus is portrait-oriented when the landscape-oriented image is being displayed, to display an image relating to the selected portrait-oriented image data in place of the landscape-oriented image.

13. The apparatus according to claim 10, wherein the classification unit generates a portrait-oriented list including the portrait-oriented image data and a landscape-oriented list including the landscape-oriented image data, and the control unit displays an image relating to the image data designated in the portrait-oriented list if the detection unit detects that the apparatus is portrait-oriented, while displaying an image relating to the image data designated in the landscape-oriented list if the detection unit detects that the apparatus is landscape-oriented.

14. An apparatus for displaying an image relating to image data stored in a storage medium, wherein orientations of a plurality of image data stored in the storage medium are respectively determined, to display, if the portrait/landscape orientation of the apparatus is changed, an image in an orientation different from an orientation of the image, which is being displayed, before the orientation is changed based on a result of the determination.

15. A control apparatus for displaying an image relating to image data on a display apparatus, the control apparatus comprising:
a detection unit configured to detect portrait/landscape orientation of the display apparatus;
a retrieval unit configured to retrieve, out of a plurality of image data, image data oriented according to the orientation detected by the detection unit; and
a control unit configured to display an image relating to the retrieved image on the display apparatus according to the orientation detected by the detection unit.

16. The control apparatus according to claim 15, wherein the detection unit detects the orientation of the display apparatus based on information sent from the display apparatus.

17. A method for controlling an apparatus including a display unit configured to display an image, the method comprising:
detecting portrait/landscape orientation of the apparatus;
retrieving, out of a plurality of image data, image data oriented according to the detected orientation; and
displaying an image relating to the retrieved image data on the display unit.

18. A method for controlling an apparatus including a display unit configured to display an image, the method comprising:
detecting portrait/landscape orientation of the display apparatus;
classifying a plurality of image data into portrait-oriented image data and landscape-oriented image data; and
selecting one of the portrait-oriented and landscape-oriented image data obtained by the classification according to the detected orientation, and displaying an image relating to the selected image data on the display unit.
